(19) United States
(12) Patent Application Publication
(10) Pub. No.: US 2006/0059463 A1
(43) Pub. Date: Mar. 16, 2006

(54) Remote build and management for software applications

(75) Inventors: Bernd Janssen, San Diego, CA (US); Banikumar Maiti, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Mobile LLC

(21) Appl. No.: 10/937,992

(22) Filed: Sep. 10, 2004

(51) Int. Cl. G06F 9/44

(52) U.S. Cl. 717/120

(57) ABSTRACT

Techniques for remotely building and managing software applications are provided. Computer code of the principal developer (e.g., source code, object code or libraries) that is not to be shared with external parties is stored on a restricted internal server while computer code of a third party supplier or customer is stored on a shared server by the supplier. A daemon executes on the restricted server to access the computer code on the shared server, download the computer code to the restricted server and call the internal compiler, linker, etc. to build the complete software application. The build is then stored or uploaded on the shared server (by the daemon) for the supplier or customer to access. Files related to the build that are desirable not to share (e.g., map files and all sensitive source code files) can be stored on the restricted server.

### BACKGROUND OF THE INVENTION

The present invention relates to developing software applications. More specifically, the invention relates to techniques for building and maintaining software applications remotely from where the software application may be being executed, tested, developed (at least partially), and the like.

When computers were in their infancy, it was very common for a single programmer to develop a software application or program. Today, however, software applications are typically orders of magnitude more complex and are programmed by many programmers. It is also fairly common for the programmers not to be employed by the same business entity, which can significantly complicate issues relating to the build of the software application.

For example, a developer may have computer code in the form of source code, object files and/or libraries that has been licensed to a supplier (or customer) to use for a product. The supplier may have their own computer code that needs to be included in the build of the software application.

A simple solution is for the developer to give (e.g., under a software license) the computer code to the supplier in order to generate the software application. Although this straight-forward approach works and is inexpensive, the developer loses control and the privacy of the computer code, which can be unsatisfactory. In instances where the developer desires to keep the computer code they developed confidential, this solution is entirely unsatisfactory.

Another solution that is utilized currently is for the developer to provide the precompiled software, the tools and potentially the hardware to the supplier for the limited purpose of building and testing the software application. In this manner, the developer maintains control over their computer code that is provided to the supplier. However, this solution can be quite expensive. Also, the developer may need to remotely maintain what is provided to the supplier, thereby utilizing more resources.

The above describes just a few examples of situations where it would be desirable to allow a software application to be built utilizing computer code from different sources, while at the same time limiting access to specific computer code. Therefore, it would be desirable to have techniques that provide this capability without unnecessarily increasing the expense, adding complicated procedures, requiring remote maintenance, and the like. Additionally, it would be beneficial if techniques were provided that allowed a supplier to flexibly build software applications with specific computer code for testing and for custom software applications.

### SUMMARY OF THE INVENTION

The present invention provides innovative techniques for remotely building and managing software applications. In general, computer code of the developer or principal company which contracts out work to multiple suppliers and is not to be shared with the suppliers is stored on a restricted (or unshared) server, while computer code of the supplier is stored on a shared server (e.g., server publicly shared or shared only between the developer and the supplier). A daemon (or other computer process) executes on the restricted server (of the developer domain) to access the computer code of the supplier on the shared server to download it into the domain of the developer's restricted server and then to build the software application. The build is then stored or uploaded back to the shared server for the supplier to access. Files related to the build that it is desirable not to share (e.g., map files) can be stored on the restricted server, which the supplier (or external developer) cannot access.

The supplier can also specify custom builds (e.g., through files stored on the shared server). This can allow variations of the build to be generated, which can be beneficial for custom applications and debugging or testing. Advantages include that computer code from different sources can be efficiently utilized to build a software application, while at the same time limiting access to specific computer code. Additionally, variations on builds can be efficiently produced without unnecessarily increasing the expense, adding complicated procedures, requiring remote maintenance, and the like. Some embodiments of the invention are described below.

In one embodiment, the invention provides a method of developing a software application. Computer code, which is to be included in a build of a software application, is accessed on shared and restricted servers. The software application is built including the computer code from the shared and restricted servers. Then, the build of the software application is stored on the shared server. The build of the software application can be from new computer code on the shared server or a request to perform the build.

In another embodiment, the invention provides a method of developing a software application. It is determined if a computer code file is new on a shared server, the computer code file being included in a build of a software application. Computer code files on shared and restricted servers are accessed that are to be included in the build of the software application, with the computer code files including the new computer code file. The software application is built including computer code files on the shared and restricted servers. Then the build of the software application is stored on the shared server.

Other features and advantages of the invention will become readily apparent upon the review of the following description in association with the accompanying drawings. In the drawings, the same or similar structures will be identified by the same reference numerals.

### BRIEF DESCRIPTION OF THE DRAWINGS

FIG. 1 illustrates an example of a computer system that can be utilized to execute software embodiments of the invention.

FIG. 2 illustrates a system block diagram of the computer system of FIG. 1.

FIG. 3 shows an example of the stored of files and build of a software application in one embodiment of the invention.

FIG. 4 shows a flowchart of a process of building a software application when a new computer code file is generated.

FIG. 5 shows a flowchart of a process of determining if a new computer code file has been generated.

### DETAILED DESCRIPTION OF EMBODIMENTS

In the description that follows, the present invention will be described in reference to embodiments that remotely build and manage software applications. However, the invention is not limited to the specific implementations, applications or architectures described herein as the invention can be implemented in different ways. Therefore the description of the embodiments that follows is for purposes of illustration and not limitation.

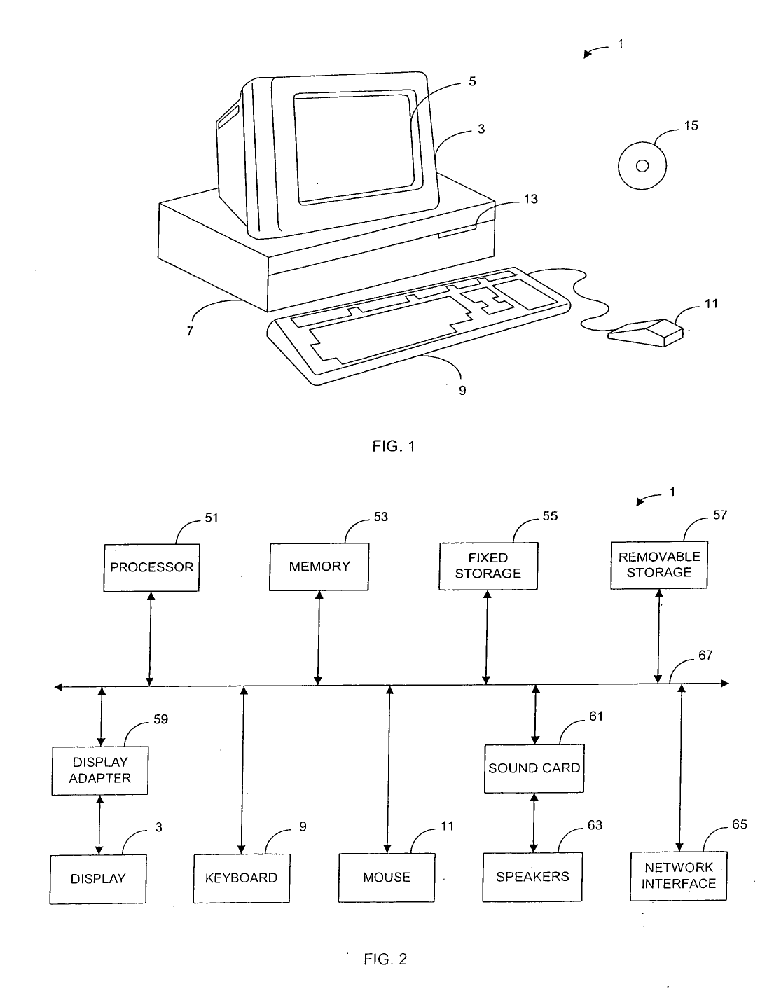

Software applications are installed and execute on computer systems. FIG. 1 illustrates an example of a computer system that can be used in association with embodiments of the invention. FIG. 1 shows computer system 1 that includes a display 3, screen 5, cabinet 7, keyboard 9, and mouse 11. Mouse 11 can have one or more buttons for interacting with a graphical user interface. Cabinet 7 houses a CD-ROM drive 13, system memory and a hard drive (see FIG. 2), which can be utilized to store and retrieve software programs incorporating computer codes that implement the invention, data for use with the invention, and the like. Although CD-ROM 15 is shown as an exemplary computer readable storage medium, other computer readable storage media including floppy disk, tape, flash memory, system memory, and hard drives can be utilized. Additionally, a data signal embodied in a carrier wave (e.g., in a network including the Internet) can be the computer readable storage medium.

FIG. 2 shows a system block diagram of computer system 1. As in FIG. 1, computer system 1 includes display 3, keyboard 9 and mouse 11. Computer system 1 further includes subsystems such as a central processor 51, system memory 53, fixed storage 55 (e.g., hard drive), removable storage 57 (e.g., CD-ROM drive), display adapter 59, sound card 61, speakers 63, and network interface 65. Other computer systems suitable for use with the invention can include additional or fewer subsystems. For example, another computer system could include more than one processor 51 (i.e., a multi-processor system) or a cache memory.

The system bus architecture of computer system 1 is represented by arrows 67. However, these arrows are illustrative of any connection scheme serving to link the subsystems. For example, a local bus could be utilized to connect processor 51 to memory 53 and display adapter 59. Computer system 1 shown in FIG. 2 is but an example of a computer system suitable for use with the invention. Other computer architectures having different configurations of subsystems can also be utilized.

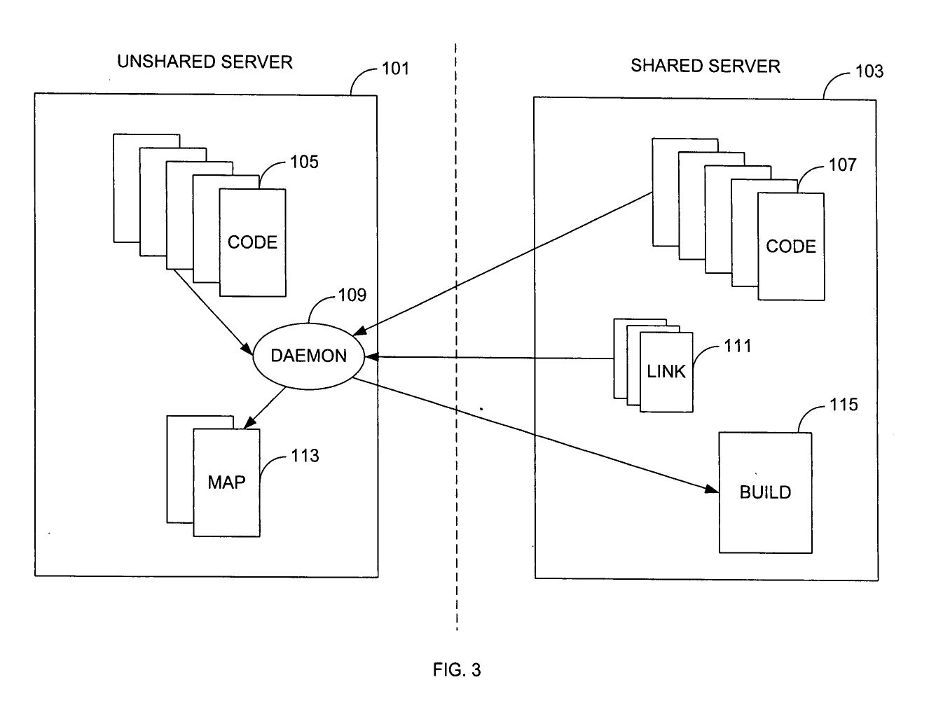

Embodiments of the invention store files that are desirable not to be shared on a restricted (or unshared) server. Files that can be shared with the supplier are stored on a shared server. FIG. 3 shows an example of files stored on an unshared and shared server. An unshared server 101 is in communication with a shared server 103 over a network (not shown). The network will typically be a wide area network, such as the Internet, but the invention can be utilized with any network configuration.

Computer code files 105 on unshared server 101 include computer code that the developer does not want to share with the supplier. The computer code can be in the form of source code, object code, libraries, and the like. These files are typically created by the developer, but they can also be created by a third party. Computer code files 107 on shared server 103 include computer code that can be shared. Typically, computer code files 107 are created by the supplier, but they can be created by a third party or even the developer (e.g., some computer code from the developer may be shared). As an example, shared server 103 can be a file transfer protocol (FTP) server.

A daemon 109 executes on unshared server 101 and is responsible for remotely building the software applications. The daemon may invoke another program to perform the actual build, but the daemon is the computer process that coordinates the builds. Daemon 109 has access to computer code files 105 and 107, which can be source code files, object code files, library files, and the like. The instructions for the builds can be specified in link files 111 stored on shared server 103. The link files may specify the computer code files to be included in the build, parameters for the build (e.g., test parameters), name of the resulting build, and the like. As shown, there can be one or more link files 111 stored on shared server 103.

During the build of a software application, files can be generated that would not be desirable to share with the supplier. For example, map files 113 that are generated during a build can be utilized to gain unauthorized information about a build of an application. Therefore, files of this type can be stored on unshared server 101. A build 115 is generated by actions coordinated by daemon 109 and the build is stored on shared server 103. Each link file 111 can specify a different build so there may be multiple builds stored on the shared server. The builds can be identified by many different methods including name of the build, time the build was created, computer code files utilized, and the like.

The availability of various link files 111 can allow a supplier to create different builds for different products. Additionally, during debugging or testing, builds can be made with different computer code files, whether stored on the unshared or shared server. This can be utilized to debug or test different portions of the software application in different builds, thereby providing great flexibility to the supplier.

In some embodiments, it may be beneficial for one or more of computer code files 107 on shared server 103 not to be shared with the developer. Those computer code files can be protected (e.g., encrypted) in such a way that daemon 109 can access the computer code, but the developer does not have access.

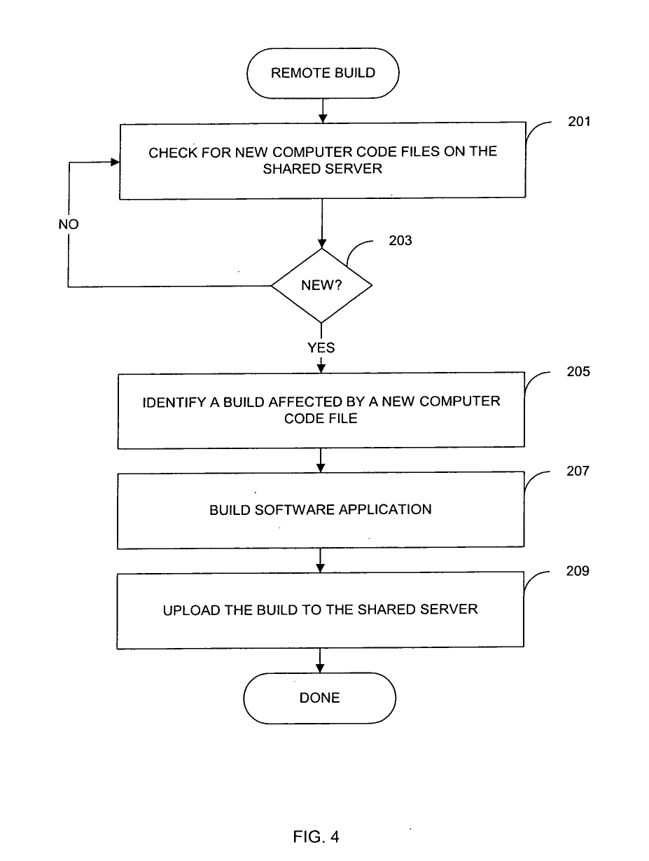

Daemon 109 can receive a request (e.g., from the supplier) to perform a build or the daemon can initiate the build on its own periodically. FIG. 4 shows a flowchart of a process of remotely building a software application when a new computer code file has been stored on the shared server. As with all flowcharts shown here, steps can be added, deleted, combined, and reordered without departing from the spirit and scope of the invention.

At a step 201, a check is performed to see if there are new computer code files on the shared server. If there is one or more new computer code files, a new build of the software application may be generated with the new computer code files. As mentioned previously, additionally, the capability to instruct a new build can also be provided.

If there are no new computer code files at a step 203, the daemon may wait for a specific amount of before performing a check for new computer code files again. Thus, the daemon may periodically check for new computer code files and generate builds when desired. If one or more new computer code files were found, a build is identified at a step 205 that is affected by a new computer code file. The builds affected by the new computer code file can be determined through an analysis of the link files. It may only take one new computer code file to cause a new build, but the build may include more than one new computer code file that was present on the shared server.

At a step 207, the software application is built including the one or more new computer code files. If, during the build, files such as map files are created that are not to be shared, these files can be stored on the unshared server. This way the supplier does not have access to these files, but the developer can access them if desired. For example, the developer can access these files at the request of the supplier.

The build is uploaded to the shared server at a step 209. Once the build is uploaded, the supplier has the ability to run the build, which includes the new computer code files. A notification can be sent to the supplier and/or developer that a new build has been created.

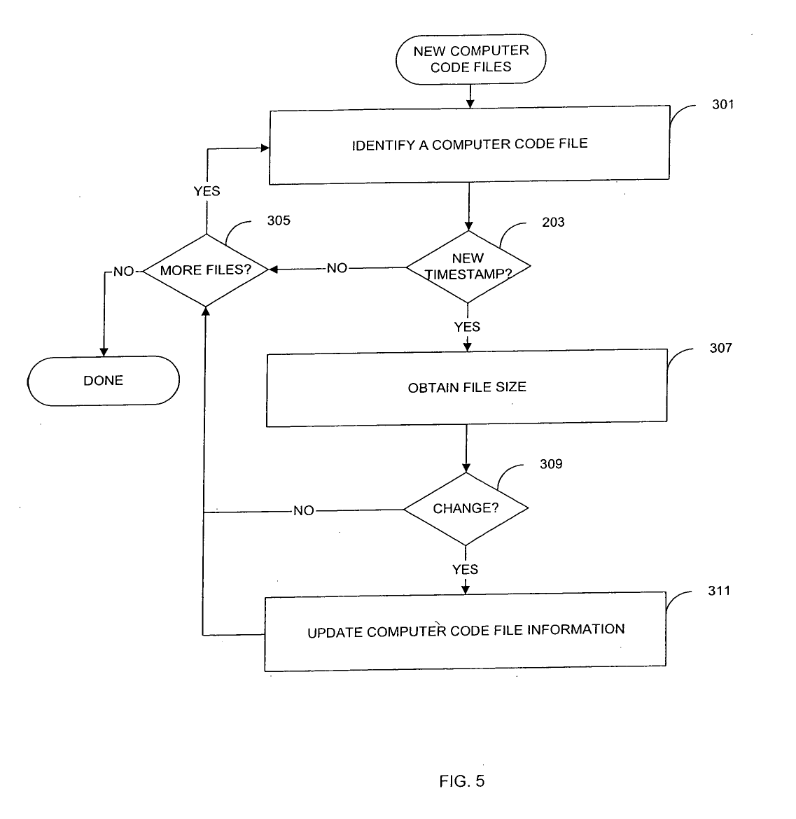

FIG. 5 shows a flowchart of a process of determining if new computer code files are present on the shared server. At a step 301, an object file is identified. As discussed previously, the daemon may periodically check the computer code files on the shared server to determine if there are any new computer code files. In some embodiments, these checks are performed at regularly intervals (e.g., every 30 minutes). In other embodiments, the checks are scheduled to be performed at off-peak hours where the resources for performing the builds is not needed. Additionally, the capability can be implemented to allow the supplier (or developer) to specifically request that a check for new computer code files is performed or an explicit building of the software application.

It is determined if the computer code file has a new timestamp at a step 303. The daemon can store timestamps, file size and other information regarding the object files on the unshared server. This information can be utilized to determine if a new computer code file has been placed on the shared server. Other techniques can be utilized to determine if an computer code file is new in other embodiments.

If it is determined the timestamp is the same for a computer code file at step 303, it is determined if there are any more computer code files to check at a step 305. If there are, those are checked as well.

If it is determined the timestamp is not the same for a computer code file at step 303, the file size of the computer code file is obtained at a step 307. This value is compared at a step 309 and if it is the same, the flow proceeds to step 305 to see if there are more computer code files to check. In the embodiment shown in FIG. 3, a change in both the timestamp and the file size indicates the computer code file is new. In other embodiments, only one of these conditions may be utilized, additional conditions may be utilized or entirely different conditions altogether may be used.

Once it is determined that an computer code file is new, the information for the computer code file is updated at a step 311. For example, the new timestamp and file size for the computer code file can be updated on the unshared server by the daemon. The flow then proceeds to step 305 to see if there are more computer code files to check.

With embodiments of the invention, the software applications can be remotely built and managed very efficiently, while still restricting access to certain computer code files and any associated files (e.g., map files). The developer retains control of confidential computer code and information without the unnecessary expense. Additionally, the supplier has flexibility to design custom builds.

While the above are complete descriptions of exemplary embodiments of the invention, various alternatives, modifications and equivalence can be used. It should be evident that the invention is equally applicable by making appropriate modifications to the embodiment described above. Therefore, the above description should not be taken as limiting the scope of the invention by the metes and bounds of the following claims along with their full scope of equivalence.

What is claimed is:

1. A method of developing a software application, comprising:
accessing computer code on shared and restricted servers that is to be included in a build of a software application;
building the software application including the computer code from the shared and restricted servers; and
storing the build of the software application on the shared server.

2. The method of claim 1, where the computer code is source code, object code or libraries.

3. The method of claim 1, further comprising storing a map file on the restricted server, the map file being generated while building the software application.

4. The method of claim 1, further comprising determining if computer code on the shared server is new.

5. The method of claim 4, further comprising wherein building the software application is performed if new computer code is on the shared server for the build.

6. The method of claim 4, wherein determining if computer code on the shared server is new comprises comparing a timestamp or file size to a previous value.

7. The method of claim 1, wherein a link file stored on the shared server specifies characteristics of the build of the software application.

8. A computer program product that develops a software application, comprising:
computer code that accesses computer code on shared and restricted servers that is to be included in a build of a software application;
computer code that builds the software application including the computer code from the shared and restricted servers;
computer code that stores the build of the software application on the shared server; and
a computer readable medium that stores the computer codes.

9. The computer program product of claim 8, wherein the computer readable medium is a CD-ROM, floppy disk, tape, flash memory, system memory, hard drive, or data signal embodied in a carrier wave.

10. A system for developing software application, comprising:
a shared server that stores computer code to be utilized in a build of a software application;
a restricted server that stores computer code to be utilized in the build of the software application; and
a daemon executing on the restricted server that accesses the computer code on the shared and restricted servers to generate the build and stores the build on the shared server.

11. The system of claim 10, where the computer code is source code, object code or libraries.

12. The system of claim 10, wherein the daemon stores a map file on the restricted server, the map file being generated while the software application is built.

13. The system of claim 10, wherein the daemon determines if computer code on the shared server is new.

14. The system of claim 13, wherein the daemon generates the build if new computer code is on the shared server for the build.

15. The system of claim 13, wherein the daemon determines if computer code on the shared server is new by comparing a timestamp or file size to a previous value.

16. The system of claim 10, wherein the daemon accesses a link file stored on the shared server that specifies characteristics of the build of the software application.

17. A method of developing a software application, comprising:
determining if a computer code file is new on a shared server, the computer code file being included in a build of a software application;
accessing computer code files on shared and restricted servers that are to be included in the build of the software application, the computer code files including the new computer code file;
building the software application including computer code files on the shared and restricted servers; and
storing the build of the software application on the shared server.

18. The method of claim 17, wherein the determining if a computer code file is new is performed at periodic intervals.

19. The method of claim 17, further comprising storing a map file on the restricted server, the map file being generated while building the software application.

20. The method of claim 17, wherein determining if a computer code file is new comprises comparing a timestamp or file size to a previous value.

21. The method of claim 17, wherein a link file stored on the shared server specifies characteristics of the build of the software application.

22. A computer program product that develops a software application, comprising:
computer code that determines if a computer code file is new on a shared server, the computer code file being included in a build of a software application;
computer code that accesses computer code files on shared and restricted servers that are to be included in the build of the software application, the computer code files including the new object file;
computer code that builds the software application including computer code files on the shared and restricted servers;
computer code that stores the build of the software application on the shared server; and
a computer readable medium that stores the computer codes.

23. The computer program product of claim 22, wherein the computer readable medium is a CD-ROM, floppy disk, tape, flash memory, system memory, hard drive, or data signal embodied in a carrier wave.

24. A system for developing software application, comprising:
a shared server that stores computer code files to be utilized in a build of a software application;
a restricted server that stores computer code files to be utilized in the build of the software application; and
a daemon executing on the restricted server that determines if an computer code file is new on a shared server, accesses computer code files on the shared and restricted servers to generate the build and stores the build on the shared server.

25. The system of claim 24, wherein the daemon determines if a computer code file is new performed at periodic intervals.

26. The system of claim 24, wherein the daemon stores a map file on the restricted server, the map file being generated while the software application is built.

27. The method of claim 24, wherein the daemon determines if a computer code file is new comprises comparing a timestamp or file size to a previous value.

28. The method of claim 24, wherein a link file stored on the shared server specifies characteristics of the build of the software application.
